(19) United States
(12) Patent Application Publication
(10) Pub. No.: US 2019/0069348 A1
(43) Pub. Date: Feb. 28, 2019

(54) VAPORIZING DEVICE SECURITY SYSTEM

(71) Applicant: August Lilley, Philadelphia, PA (US)

(72) Inventor: August Lilley, Philadelphia, PA (US)

(21) Appl. No.: 16/110,423

(22) Filed: Aug. 23, 2018

Related U.S. Application Data
(60) Provisional application No. 62/549,662, filed on Aug. 24, 2017.

(51) Int. Cl. H05B 1/02; G05B 15/02; F24F 6/02

(52) U.S. Cl. CPC H05B 1/0297; F24F 6/025; G05B 15/02

(57) ABSTRACT

A vaporizing device security system is provided. The vaporizing device security system embodies a vaporizing device heating element controller coupled to a heating element and associated software. The heating element controller is adapted to enable only a user with a registered smart device to selectively activate and control the heating element. Thereby providing a security system for preventing the heating element from being activated by unauthorized users. The associated software is adapted to provide a user-friendly user interface on the registered computing device for activating, controlling, and setting the preferences of the heating element controller.

### CROSS-REFERENCE TO RELATED APPLICATION

This application claims the benefit of priority of U.S. provisional application No. 62/549,662, filed 24 Aug. 2017, the contents of which are herein incorporated by reference.

### BACKGROUND OF THE INVENTION

The present invention relates to vaporizing devices and, more particularly, to a vaporizing device security system configured to enable a user smart device to selectively activate and control the heating element of the vaporizing device, as well as remotely set preference for the vaporizing device, while having a user-friendly application-based user interface.

Vaporizing devices that plug into the wall and require constant power for use are becoming popular but they raise safety concerns for home use, especially in a home with children. Generally, current vaporizing devices use antiquated PID controllers that offer minimal control over device preferences cast in a difficult array of physical buttons. Specifically, current vaporizing devices work with controllers originally designed for industrial purposes, leaving commercial users with difficulty operating the vaporizing device since the current offerings lack sophisticated computing functionality required to provide all the features that users want, including user-interfaces that are user-friendly to understand and operate.

As can be seen, there is a need for a vaporizing device security system embodying a heating element controller working in conjunction with software to allow a user with a registered smart device to control activation and functionality of the heating element controller, as well as access to the preferences thereof—securely controlling if, when, and how the heating of the vaporizing device will work.

By designing a computer-implemented heating element controller with accompanying user-facing software, the present invention allows users with registered smart devices to control the heating element through verification of a unique identifier, such as a unique QR code, that disables use of the heating element controller without verification by the registered smart device with a matching identifier. This necessary user-specific operative association prevents other individuals from having control over the heating element; thereby, enabling users to child-lock the device, wherein one cannot power the heating element without first gaining access through the matching of the unique identifier.

### SUMMARY OF THE INVENTION

In one aspect of the present invention, a vaporizing device security system includes a registered smart device providing a user interface; the registered smart device in receipt of a registered identifier; and a heating element controller providing an onboard computing device providing a unique onboard identifier; and a heating element coupled to the onboard computing device; the onboard computing device configured to operatively associate the heating element to the registered smart device if the registered identifier matches the onboard identifier.

In another aspect of the present invention, the vaporizing device security system includes a registered smart device providing a user interface; the registered smart device in receipt of a registered identifier, wherein the registered identifier is transmitted to the registered smart device only after an initial registration process and wherein the registered smart device is configured to reproduce the registered identifier on the user interface; and wherein the onboard computing device is configured to read said reproduction; and a heating element controller providing: an onboard computing device providing a unique onboard identifier; a heating element coupled to the onboard computing device, wherein the heating element is dimensioned and adapted for vaporizing devices; a plurality of indicator outputs coupled to the onboard computing device; the plurality of indicator outputs configured to indicate temperature and time related parameters of the heating element; the onboard computing device configured to operatively associate the heating element to the registered smart device if the registered identifier matches the onboard identifier, and wherein the heating element controller is configured to enable said user interface to control temperature and time related parameters of the heating element.

These and other features, aspects and advantages of the present invention will become better understood with reference to the following drawings, description and claims.

### BRIEF DESCRIPTION OF THE DRAWINGS

FIG. 1 is a front and rear perspective view of an exemplary embodiment of the present invention;

FIG. 2 is a schematic view of an exemplary embodiment of the present invention;

FIG. 3 is a schematic view of an exemplary embodiment of the present invention; and

FIG. 4 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a vaporizing device security system embodying a heating element controller and associated software. The heating element controller is adapted to enable only a user with a registered smart device to selectively activate and control a vaporizing device heating element of the heating element controller. Thereby, providing a security system for preventing the heating element being activated by unauthorized users. The heating element controller is also adapted to provide a user-friendly user interface on the registered computing device for activating, controlling, and setting the preferences of the heating element controller.

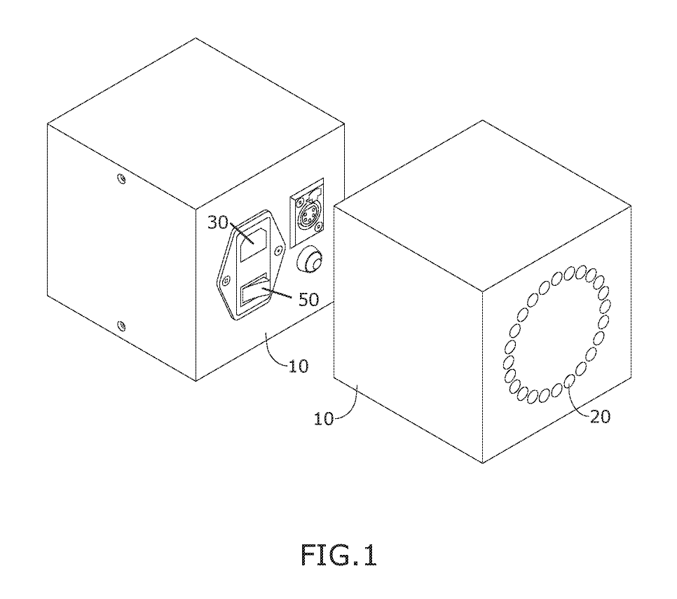

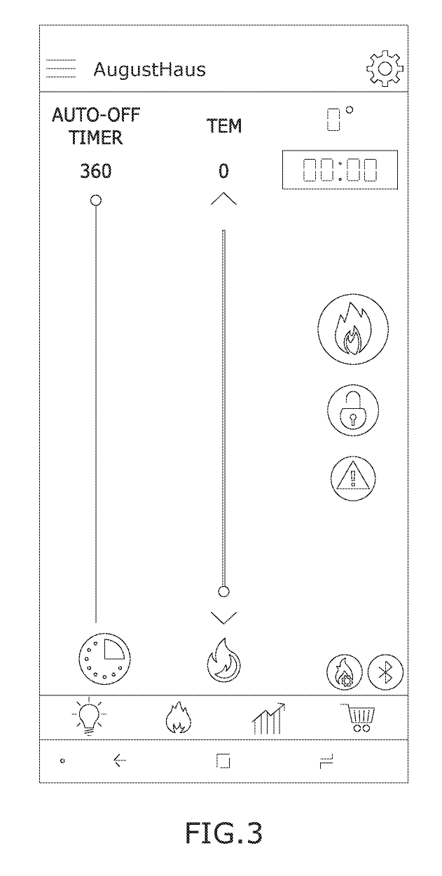

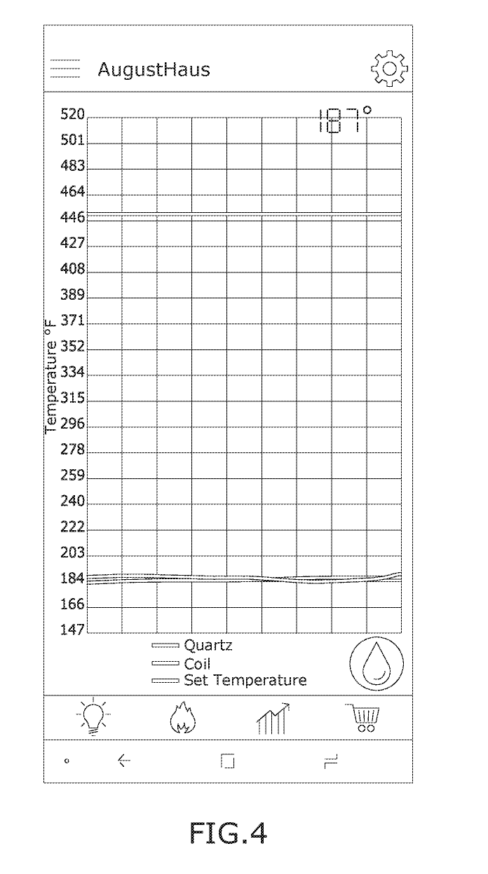

Referring to FIGS. 1 through 4, the present invention may include two or more computing devices, each with a user interface. Each computing device may include at least one processing unit coupled to a form of memory. The computing device may include, but not limited to a microprocessor, a server, desktop, laptop, and a smart device, such as, a tablet and smart phone. The computing devices may include a program product including a machine-readable program code for causing, when executed, the computing device to perform steps. The program product may include software which may either be loaded onto the computing devices or accessed by the computing devices. The loaded software may include an application on a smart device. The software may be accessed by the computing devices using a web browser. The computing devices may access the software via the web browser using the internet, extranet, intranet, host server, internet cloud and the like.

The present invention embodies a heating element controller 10 coupling an onboard computing device and to a heating element 30 (for a vaporizing device) and a plurality of indicator outputs 20. The onboard computing device has vaporizing control software application loaded thereon, such as AugustHaus Code Generator proprietary software and/or AugustHaus KubeOne iOS and android applications. The onboard computing device is associated with a unique identifier (onboard identifier), wherein the heating element 30 is configured to be activated only when a registered smart device 40 provides a matching identifier (registered identifier). In other words, the heating element controller 10 is only operable by a registered smart device 40 providing a registered identifier that matches the onboard identifier.

Each heating element controller 10 may provide its own unique onboard identifier. The software application may generate the one and only associated matching registered identifier for a user's computing device (smart device) 40 after the user goes through an initial registration process with the smart device 40. The registration process may include prompts, confirmations, permission requests, and terms of use offer and acceptance. The software application may be adapted to export the matching registered identifier from the onboard computing device to the properly registered computing device 40. In certain embodiments, the registered smart device 40 may have an associated mobile application adapted to create an electronic representation of the matching registered identifier in the form of, for example, a unique QR code.

In certain embodiments, the heating element controller 10 may be developed with a controller schematic side by side an integrated software, wherein the onboard identifier of the onboard computing device can be generated with a unique serial number every time a new product is assembled. Adding the software application, though, that generates each onboard code uniquely makes the product work better and without conflict.

As mentioned above, the user must scan the registered identifier (QR code) via the mobile application to make a secure, operatively association with the heating element controller 10. The heating element controller 10 may provide a machine reading element (not shown) for scanning a reproduction of the registered identifier. In other embodiments, the user interface of the registered device 40 may prompt the user to enter the registered identifier through the mobile application when the registered smart device 40 is within a proximate distance of the heating element controller 10. Again, when the matching registered identifier is provided, then the registered smart device and the onboard computing device are operatively associated.

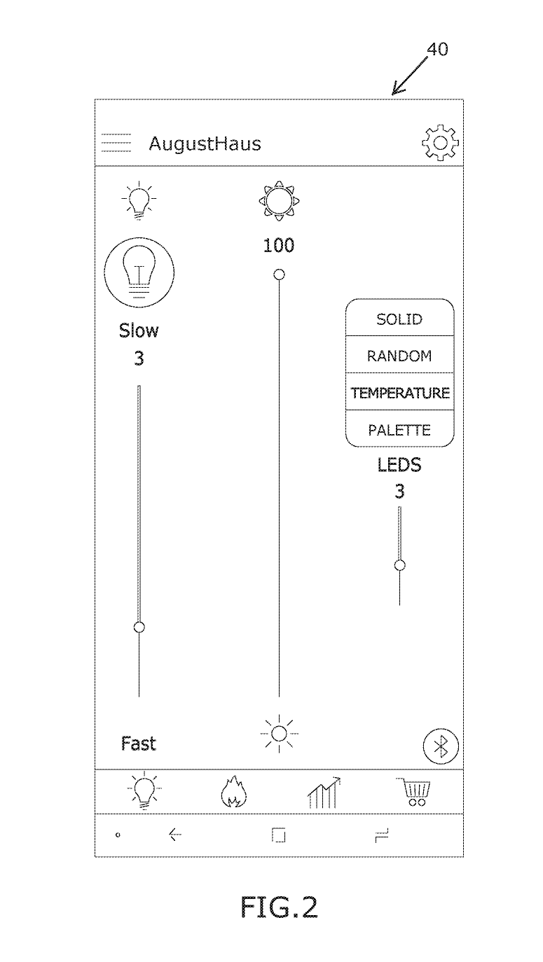

The onboard computing device of the heating element controller 10 provides proprietary logic enabling the users to control it from smart devices without conflict through such operative association. The onboard computing device software application may be Bluetooth (or other sufficient short-range wireless signals) enabled and configured to control the heating element 30 and indicator output 20 (such as LED lights) provided by the heating element controller 10. The onboard computing device may configure the registered computing device as a user-interface of the heating element controller 10 for selectively controlling all the features thereof, as illustrated in FIGS. 2 through 4. The indicator output 20 in certain embodiments may be a circle of LED lights of different colors, as illustrated in FIG. 1. The circle of LEDs may be adapted to indicate how hot the heating element 30 is. The heating element controller 10 provides a timing component enabling a user, through the user interface, to select a time to activate or turn off the heating element 30, or for how long to maintain a temperature or to indicate how long the heating element 30, and the like (possibly through the indicator output 20).

The heating element controller 10 provides an on-off power button 50. In certain embodiments, the heating element controller 10 may only be turned off or on with the matching registered identifier—registered smart device 40. In other embodiments, the power button 50 can be used if no operative association is made through matching the registered identifier.

The onboard computing device will use onboard memory to store the settings commanded by the user's smart device 40 through the mobile application. As mentioned above, the mobile application may be configured to scan an electronic representation of the unique QR code, which when identified by the onboard computing device makes a secure wireless connection. The user cannot connect to the heating element controller 10 without matching/scanning the unique QR code.

A method of using the present invention may include the following. The vaporizing device security system, including the heating element controller 10, disclosed above may be provided. A user may download the vaporizing software application and register their smart device as a registered computing device 40, thereby receiving a registered identifier. The heating element controller 10 may be enabled to scan the registered identifier (in certain embodiments, a unique QR code represented on the user interface of the registered computing device 40). The user interface of the registered computing device 40 is thereby enabled to in essence to become the user interface of the heating element controller 10—whereby the user may activate, control and select the settings and preferences thereof—having integrated logic and explanatory logos.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A vaporizing device security system, comprising:
a registered smart device providing a user interface; the registered smart device in receipt of a registered identifier; and
a heating element controller comprising:
an onboard computing device providing a unique onboard identifier; and
a heating element coupled to the onboard computing device; the onboard computing device configured to operatively associate the heating element to the registered smart device if the registered identifier matches the onboard identifier.

2. The vaporizing device security system of claim 1, wherein the heating element is for vaporizing devices.

3. The vaporizing device security system of claim 1, wherein the heating element controller further comprising a plurality of indicator outputs coupled to the onboard computing device; the plurality of indicator outputs configured to indicate temperature and time related parameters of the heating element.

4. The vaporizing device security system of claim 1, wherein the heating element controller is configured to enable said user interface to control temperature and time related parameters of the heating element.

5. The vaporizing device security system of claim 1, wherein the registered identifier is transmitted to the registered smart device only after an initial registration process.

6. The vaporizing device security system of claim 1, wherein the registered smart device is configured to reproduce the registered identifier on the user interface; and wherein the onboard computing device is configured to read said reproduction.

7. The vaporizing device security system of claim 1, wherein the heating element controller further comprises a power button having operability independent of the operative association.

8. The vaporizing device security system of claim 1, wherein the heating element controller further comprises a power button having an operability dependent on the operative association.

9. A vaporizing device security system, comprising:
a registered smart device providing a user interface; the registered smart device in receipt of a registered identifier, wherein the registered identifier is transmitted to the registered smart device only after an initial registration process and wherein the registered smart device is configured to reproduce the registered identifier on the user interface; and wherein the onboard computing device is configured to read said reproduction; and
a heating element controller comprising:
an onboard computing device providing a unique onboard identifier;
a heating element coupled to the onboard computing device, wherein the heating element is dimensioned and adapted for vaporizing devices;
a plurality of indicator outputs coupled to the onboard computing device; the plurality of indicator outputs configured to indicate temperature and time related parameters of the heating element;
the onboard computing device configured to operatively associate the heating element to the registered smart device if the registered identifier matches the onboard identifier, and wherein the heating element controller is configured to enable said user interface to control temperature and time related parameters of the heating element.

10. The vaporizing device security system of claim 9, wherein the heating element controller further comprises a power button having operability independent of the operative association.

11. The vaporizing device security system of claim 9, wherein the heating element controller further comprises a power button having an operability dependent on the operative association.
